(19) United States
(12) Patent Application Publication
(10) Pub. No.: US 2026/0084549 A1
(43) Pub. Date: Mar. 26, 2026

(54) COMPACT CHARGING ADAPTER

(71) Applicants: Christopher Eckhard Maiwald, Kowloon (HK); German Chan, Kowloon (HK); Alex Liu, Shenzhen City (CN); Jason Chen, Shenzhen City (CN)

(72) Inventors: Christopher Eckhard Maiwald, Kowloon (HK); German Chan, Kowloon (HK); Alex Liu, Shenzhen City (CN); Jason Chen, Shenzhen City (CN)

(21) Appl. No.: 18/892,632

(22) Filed: Sep. 23, 2024

(51) Int. Cl. B60L 53/16; H01R 31/06

(52) U.S. Cl. CPC B60L 53/16; H01R 31/06

(57) ABSTRACT

A cross-standard electric vehicle (EV) charging adapter enables compatibility between different EV charging standards, including allowing CCS1-equipped vehicles to access the North American Charging Standard (NACS) network, which includes the Tesla Supercharger network. By enabling cross-standard charging compatibility, the limitations of existing charging infrastructure are overcome, enhancing accessibility and convenience for all EV owners. The adapter supports high-power charging up to 500 kW, ensuring rapid and efficient charging for a wide range of electric vehicles. An advanced temperature control system to prevent overheating and an interlock mechanism may ensure secure connections. A durable, compact design that simplifies manufacturing while maintaining reliability and safety is provided.

### PRIORITY CLAIM

This application claims priority to U.S. Patent Application No. 63/664,286, filed Jun. 6, 2024, and titled “COMPACT CHARGING ADAPTER,” the contents of which are incorporated by reference in its entirety.

### FIELD OF INVENTION

The present invention relates to the field of electric vehicle (EV) charging technology, specifically focusing on adapter devices that enable interoperability between different EV charging standards, thereby enhancing charging accessibility and convenience for EV owners across various brands.

### BACKGROUND

The rapid growth of the electric vehicle (EV) market has led to the proliferation of various charging standards, with Tesla's North American Charging Standard (NACS) and the Combined Charging System Type 1 (CCS1) being the most prominent in North America. However, these different standards have created significant barriers for EV owners, particularly those unable to access Tesla's extensive Supercharger network. This limitation reduces the convenience and accessibility of charging infrastructure, particularly in areas where non-Tesla charging stations are sparse or unreliable. The need for a solution that bridges this gap is critical for promoting the broader adoption of electric vehicles and ensuring that all EV owners have equitable access to fast charging options.

Existing solutions, such as standalone charging stations compatible with CCS1 or third-party adapters, often fall short due to limitations in power handling, safety concerns, and lack of widespread availability. Many adapters available on the market are not capable of supporting the high power output required for rapid charging, leading to slower charging times and increased inconvenience for users. Moreover, concerns about the safety and reliability of these adapters have also been raised, as improper connections or overheating can pose significant risks to both the vehicle and the user. These challenges underscore the need for a more robust, high-performance adapter that can safely and efficiently enable CCS1 vehicles to access DC charging stations such as the Tesla Supercharger network.

Embodiments of the adapter of the present invention were developed in direct response to these challenges, providing a comprehensive solution that addresses the limitations of existing technologies. By offering a high-power adapter capable of handling up to 500 kW, the adapter ensures that CCS1 vehicle owners can benefit from the same rapid charging capabilities as Tesla owners. The adapter's advanced safety features, including a secure interlock mechanism and integrated thermal management system, further enhance its reliability and safety, making it a critical tool for expanding the usability of EV charging infrastructure. This innovation solves the immediate problem of incompatible charging standards and supports the long-term growth and adoption of electric vehicles by making charging more accessible and convenient for all users.

### OBJECTS OF THE INVENTION

Some of the objects of the present disclosure, which at least one embodiment herein satisfies, are as follows.

An object of the present disclosure is to create an adapter that allows CCS1-equipped vehicles to These challenges underscore the need for a more robust, high-performance adapter that can safely and efficiently enable CCS1 vehicles to access DC charging stations such as the Tesla Supercharger network, thereby expanding charging options for EV owners.

Another object of the present disclosure is to design an adapter capable of handling high power output up to 500 kW (e.g., 500 A current rating and a 1000V voltage rating), ensuring rapid and efficient charging for electric vehicles.

Still another object of the present disclosure to incorporate a robust interlock mechanism that prevents accidental disconnections during charging, ensuring safety and reliability.

Another object of the present disclosure is to integrate a temperature control system that maintains safe operating conditions, preventing overheating and enhancing adapter longevity.

Still another object of the present disclosure is to use high-quality materials and protective O-ring seals to safeguard the internal components from dust, moisture, and environmental damage.

Still another object of the present disclosure to design an adapter with safety features such as micro switches and pilot signal management to prevent electrical hazards.

Yet another object of the present disclosure is to develop a modular and compact design that simplifies manufacturing processes, reducing production costs and increasing reliability.

Other objects and advantages of the present disclosure will be more apparent from the following description, which is not intended to limit the scope of the present disclosure.

### SUMMARY OF THE INVENTION

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

The present invention is generally directed to a cross-standard electric vehicle charging adapter, a device designed to bridge the gap between different electric vehicle (EV) charging standards, specifically enabling CCS1-equipped vehicles to access DC charging stations such as the Tesla Supercharger network. This adapter supports high-power charging up to 500 kW, ensuring rapid and efficient charging for a wide range of EVs. It incorporates advanced safety features, including an integrated temperature control system, and durable O-ring seals, which collectively ensure reliable and safe operation under various conditions. The adapter's modular and compact design not only enhances durability but also simplifies manufacturing, making it a cost-effective solution for expanding EV charging infrastructure. By enabling cross-standard compatibility, embodiments of the adapter play a critical role in promoting the widespread adoption of electric vehicles and improving charging accessibility for all users.

Embodiments of the cross-standard electric vehicle charging adapter offer a range of advantages for EV owners. By enabling CCS1-equipped vehicles to access Tesla's Supercharger network, it greatly expands charging options and convenience. The adapter supports high-power output up to 500 kW, allowing for rapid charging and reduced wait times. Its secure connection system ensures a stable and safe charging experience, while an integrated temperature control system prevents overheating and safeguards the adapter's components. Built with high-quality materials and protective O-ring seals, it boasts enhanced durability and reliable performance in various conditions. This universal compatibility fosters broader adoption of electric vehicles by facilitating cross-standard charging between CCS1 and Tesla networks. Additionally, its modular design streamlines production, making it a cost-effective option and accessible to a wider market. Designed for ease of use, it provides a seamless charging experience for EV owners across different vehicle makes and models.

### BRIEF DESCRIPTION OF THE DRAWINGS

The features and advantages of the present disclosure will be more fully understood with reference to the following detailed description when taken in conjunction with the accompanying figures, wherein:

FIG. 1 depicts a cross-standard electric vehicle charging adapter, according to aspects of the present disclosure.

FIG. 2 depicts a busbar system that may be used with a cross-standard electric vehicle charging adapter, according to aspects of the present disclosure.

FIG. 3 depicts a microswitch assembly for use with a cross-standard electric vehicle charging adapter, according to aspects of the present disclosure.

FIG. 4 depicts a temperature control and sensing system layout, including temperature sensors and the printed circuit board (PCB), according to aspects of the present disclosure.

FIG. 5 depicts an interlock mechanism for use with a cross-standard electric vehicle charging adapter, according to aspects of the present disclosure.

### DETAILED DESCRIPTION

In embodiments of the invention, a cross-standard electric vehicle charging adapter is disclosed, which is designed to enable electric vehicles (EVs) compatible with a first charging standard to access a second charging standard. In a preferred embodiment, the first charging standard is, for example, the Combined Charging System Type 1 (CCS1) standard and the second charging standard is, for example, the North American Charging Standard (NACS) employed by the Tesla Supercharger network.

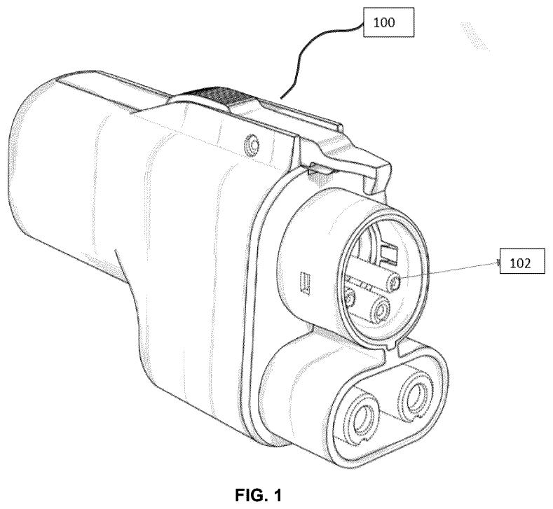

Referring to FIG. 1, an exemplary adapter is shown. The housing of adapter 100 may be engineered from high-durability materials to ensure robustness and longevity. One example of such a material is the thermoplastic polycarbonate resin sold under the Panlite(R) brand by Teijin Limited.

The housing may also be designed with an ergonomic grip for ease of handling by users. Adapter 100 is preferably shaped to interface with the respective charging standards at the opposite ends of the unit, having a first end and a second end. Adapter 100 comprises a housing that may contain, for example, electronics and other components for bridging the charging standards.

In embodiments of the invention, the device may feature a robust external casing (100) made from high-durability materials. In embodiments of the invention, heat dissipation channels may be provided in the adapter for managing thermal output during high-current charging sessions. Such a design may prevent overheating and ensure safe operation while providing an ergonomic grip for convenient handling.

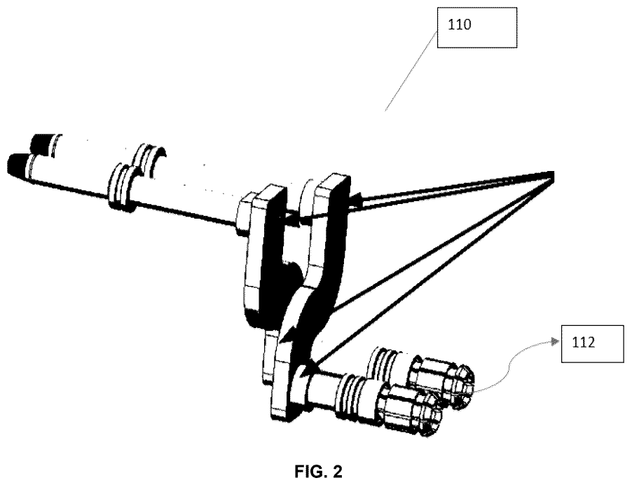

Referring to FIG. 2, a busbar system 110 is shown, which may function as an electrical connection point that gathers electric power from incoming feeders and then disperses it to outgoing feeders. In embodiments, the core electrical connection within the adapter may be managed by a series of busbars, which may preferably be crafted from copper with silver and nickel plating. Busbar system 110 may be engineered in a three-piece design that optimizes space within the compact adapter, reduces manufacturing defects, and enhances electrical conductivity. The busbars may be precision-laser welded to minimize electrical resistance and ensure secure connections.

Referring to FIG. 2, in embodiments of the invention, a busbar system 110 may be provided as a three-piece design 112 to optimize space within the compact casing, minimize manufacturing defects, and maximize electrical conductivity. The optional busbars may be connected using precision-laser welding, which reduces electrical resistance and ensures secure, reliable connections for efficient current transfer. In embodiments, the novel busbar configuration may enhance the compact size of the adapter.

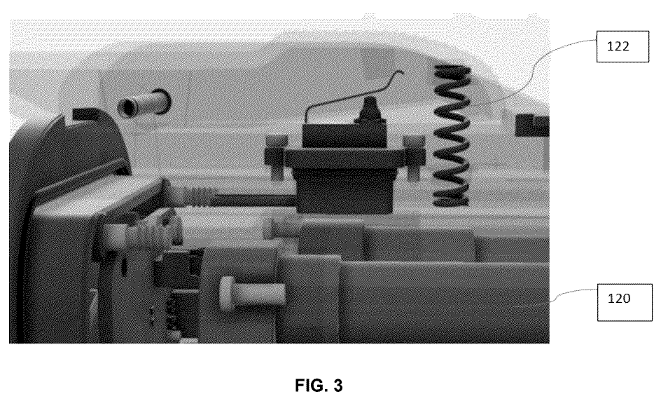

FIG. 3 depicts a microswitch assembly internal to the housing of FIG. 1. The microswitch assembly may feature an additional lever 122 that is strategically positioned to trigger the switch earlier in the latching/unlatching process. This design enhancement ensures the reliable activation of the adapter's electrical systems and improves the user experience by reducing the likelihood of connection failures.

Referring to FIG. 3, a microswitch system 120 may be provided with an additional lever 122 strategically positioned to activate the switch earlier in the connection process. This enhancement improves the reliability of the electrical systems by ensuring proper engagement of the switch before full connection, thus reducing the likelihood of failures and enhancing performance.

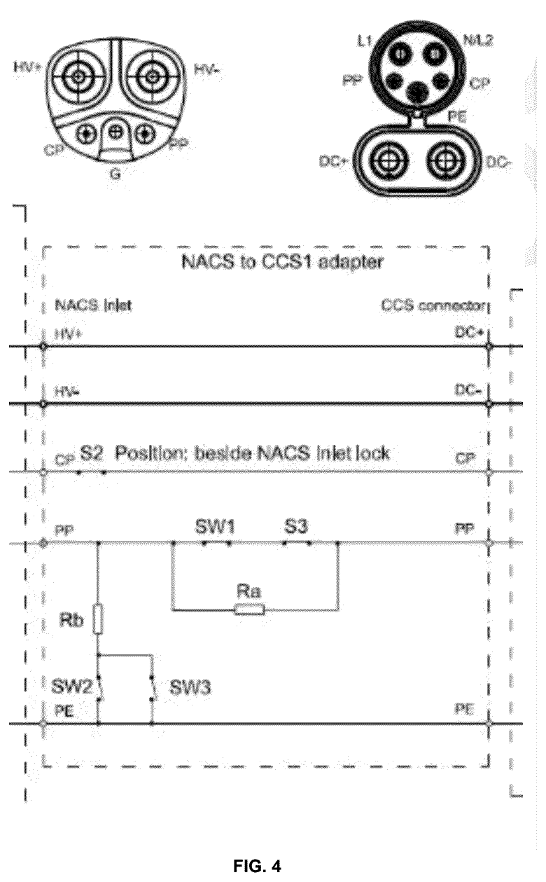

FIG. 4 depicts a schematic diagram of a temperature control and sensing system layout, including a temperature sensor. A temperature sensor may be connected to a printed circuit board (PCB) that regulates the adapter's pilot signals, ensuring safe operation by preventing overheating during the charging process.

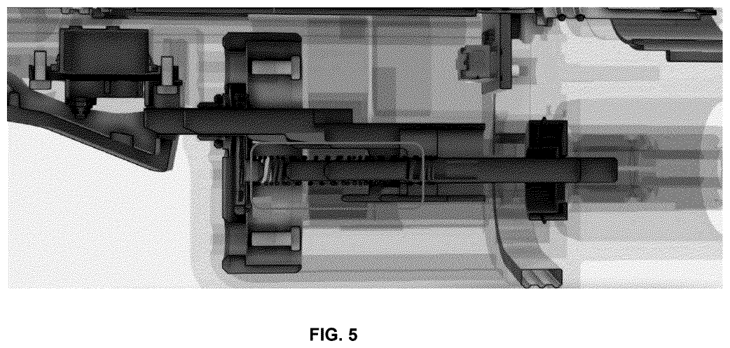

FIG. 5 depicts an exemplary interlock mechanism 140, featuring the pin, spring system, and interlock cavity with O-rings and screws. To secure the NACS latch during charging, the adapter includes an advanced interlock system. A pin may be positioned between the DC terminals on the CCS1 side and is activated upon connection to the vehicle. This mechanism is supported by a spring system within the interlock cavity, allowing the pin to move in and out as needed. The cavity is sealed with O-rings at both ends, ensuring waterproofing and dust resistance, and is further secured by screws to prevent tampering or accidental disengagement.

In embodiments, the cross-standard electric vehicle charging adapter may be configured to accommodate a maximum current of 500 A and a voltage of up to 1000V DC. This allows for rapid charging of EVs, with the capability to deliver up to 500 kW of power, significantly reducing the time required to recharge a vehicle's battery.

In addition to the temperature control system, the adapter may include an optional interlock design capable of withstanding a pulling force of up to 800N on the coupler, ensuring the connection remains secure even under stress. This is critical for maintaining safe operation in high-traffic environments where the adapter may be subjected to physical strain.

The operation of the cross-standard electric vehicle charging adapter will now be described. In embodiments of the invention, the cross-standard electric vehicle charging adapter is a high-performance device designed to bridge two otherwise incompatible charging standards.

Because of the importance of temperature management, the device may feature an advanced temperature control and sensing system 130. Integrated temperature sensors 132 may be connected to a printed circuit board (PCB) that regulates the adapter's pilot signals. The PCB may monitor and control the temperature to prevent overheating, adjusting power output or disconnecting the charging process if necessary to protect both the device and the vehicle's battery.

In embodiments, an interlock mechanism 140 may be provided to ensure a secure connection. A pin 142 positioned between the DC terminals on the CCS1 side locks the adapter to the vehicle's charging port. Supported by a spring system 144 within the interlock cavity 146, the pin moves smoothly and is protected against dust and moisture by O-rings 148. The cavity is also secured with screws 150 to prevent accidental dislodgement.

With a maximum current rating of 500 A and a voltage capacity of up to 1000V DC, the device can deliver up to 500 kW of power, enabling rapid charging of even the largest EV batteries and reducing charging times significantly. In embodiments of the invention, an optional interlock mechanism may be provided to to withstand a pulling force of up to 800N, ensuring that the connection remains secure under physical stress, crucial for high-traffic environments.

The device's design has undergone extensive testing and simulation, with a prototype confirming that it meets all required safety and performance standards. This rigorous testing ensures that the adapter performs reliably across various conditions, providing a robust solution for connecting CCS1-equipped vehicles to Tesla's Supercharger network.

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention.

While the present invention is described herein by way of example using embodiments and illustrative drawings, those skilled in the art will recognize that the invention is not limited to the embodiments of drawing or drawings described and is not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A charging adapter for connecting an electric vehicle compliant with a first charging standard to a charging station compliant with a second charging standard, comprising:
a housing configured to enclose components of the charging adapter;
a micro switch connected to a busbar system, the micro switch including an additional lever configured to trigger the switch upon connection, ensuring early activation of the charging adapter's electrical circuits;
a temperature control system comprising integrated temperature sensors and a printed circuit board (PCB), wherein the PCB regulates the adapter's pilot signals and adjusts power output based on temperature readings to prevent overheating;
an interlock mechanism positioned within the housing, the interlock mechanism including a spring-loaded pin positioned between direct current (DC) terminals on a Combined Charging System (CCS) 1 side, the pin being movable within a sealed cavity to secure the charging adapter to a vehicle's charging port; and
an interlock mechanism within the housing, the interlock mechanism including a pin positioned between dc terminals on the ccs1 side, the pin being spring-loaded and movable within a sealed cavity to secure the charging adapter to the vehicle's charging port; and
wherein the charging adapter is capable of transmitting a maximum current of 500 A and a voltage of 1000V DC for high-power charging.

2. The device of claim 1 wherein a busbar system positioned within the housing, the busbar system comprising multiple copper busbars plated with silver and nickel for efficient electrical conductivity, the busbars being laser-welded to reduce electrical resistance;

3. The charging adapter of claim 1, further comprising a busbar system positioned within the housing, the busbar system comprising multiple copper busbars plated with silver and nickel to enhance electrical conductivity, the busbars being laser-welded to minimize electrical resistance.

4. The charging adapter of claim 1, wherein the housing further includes heat dissipation channels configured to manage thermal output during high-current charging sessions.

5. The charging adapter of claim 1, wherein the busbar system includes a three-piece design configured to optimize space within the housing and reduce manufacturing defect rates.

6. The charging adapter of claim 1, wherein the micro switch's additional lever is configured to enhance connection reliability by reducing the likelihood of connection failure during the charging process.

7. The charging adapter of claim 1, wherein the temperature control system is configured to automatically disconnect the charging process if the temperature exceeds a predefined safety threshold.

8. The charging adapter of claim 1, wherein the interlock mechanism further comprises O-rings on both ends of the cavity to provide sealing against dust and moisture.

9. The charging adapter of claim 1, wherein the interlock mechanism is capable of withstanding a pulling force of up to 1400N, ensuring the adapter remains securely connected to the vehicle under stress.

10. The charging adapter of claim 1, wherein the adapter is configured to deliver up to 500 kW of power, enabling rapid charging of electric vehicles with large battery capacities.
